(19) United States
(12) Patent Application Publication
(10) Pub. No.: US 2010/0237818 A1
(43) Pub. Date: Sep. 23, 2010

(54) DRIVING CIRCUIT FOR BRUSHLESS MOTOR USING HALL ELEMENT

(75) Inventors: Yuichi Ohkubo, Gunma (JP); Hiroyuki Kikuta, Kyoto (JP); Norihiro Kawagishi, Shizuoka (JP); Kazuyoshi Asakawa, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/722,172

(22) Filed: Mar. 11, 2010

(30) Foreign Application Priority Data
Mar. 19, 2009 (JP) 2009-068516

(51) Int. Cl. H02K 29/08

(52) U.S. Cl. 318/400.38

(57) ABSTRACT

A driving circuit feeds driving current to a coil in a brushless motor, and feeds bias current to a Hall element that senses the rotational position of the motor. The driving current and bias current are supplied from the same power supply, but the bias current passes through a load element that reduces power dissipation by the Hall bias circuit by causing some of the power to be dissipated by the load element instead. The Hall bias circuit can therefore be combined with the other driving circuitry into a single integrated circuit, even if the brushless motor is driven at a comparatively high voltage.

### BACKGROUND OF THE INVENTION

1. Field of the Invention

The present invention relates to a driving circuit for a brushless motor, more particularly to a driving circuit employing a Hall element to detect the rotational position of the brushless motor.

2. Description of the Related Art

A conventional driving circuit of this type is described by Okada et al. in Japanese Patent Application Publication No. 2007-037386. The driving circuit drives a single-phase brushless motor and has the structure shown in FIG. 1.

Except for the Hall element 100, the motor coil 200, and, in some cases, the power transistors (not shown), the driving circuit S is formed as an integrated circuit 104 on a single semiconductor chip powered by a power supply 102. The integrated circuit 104 has a Hall bias circuit 106 that outputs a bias voltage VB to the Hall element 100, which is typically mounted on the stator of the brushless motor, causing current to flow through the Hall element 100 to ground. The Hall element 100 has output terminals A, B from which it outputs a complementary pair of sinewave signals SHA, SHB indicating the rotational position of the rotor of the brushless motor. The frequency of these Hall signals SHA, SHB also indicates the rotational speed of the motor. For a single-phase motor, there is only one Hall element 100, and only one pair of amplifiers 108, 110 is needed to amplify the difference between the Hall signals and determine the current to be fed through the coil 200 in the stator. As the rotor turns, the output voltage of amplifier 108 is alternately higher than and lower than the output voltage of amplifier 110, and the current fed through the coil 200 reverses direction at the proper timings to provide motor torque.

In the conventional driving circuit S in FIG. 1, power is supplied at the same voltage both to the amplifiers 108, 110 to power the motor and to the Hall bias circuit 106 to bias the Hall element 100. A consequent problem is that when a comparatively high torque is required and thus a comparatively high supply voltage is used, the Hall bias circuit 106 dissipates so much power that it cannot be placed together with the amplifiers 108, 110 in the same package without causing the package to overheat.

When the supply voltage is only five volts (5 V), for example, if the bias current fed through the Hall element 100 is ten milliamperes (10 mA) and the total current consumed by the other control circuits in the integrated circuit 104 is 3 mA, the total power dissipation is only about 0.065 watts (0.065 W, calculated as (10 mA+3 mA)×5 V), which is not problematic.

If the coil 200 is driven at 50 V, however, the total power dissipation becomes 0.65 W (calculated as (10 mA+3 mA)×50 V), which stresses the heat dissipating capabilities of some types of packages.

### SUMMARY OF THE INVENTION

An object of the present invention is to provide a brushless motor driving circuit that can be housed in a single package even if the motor is driven at a high voltage.

The driving circuit provided by the invention drives a brushless motor by using current supplied at a first voltage by a power supply. The driving circuit includes a driving voltage generating circuit for generating voltages for driving the brushless motor, a Hall element that faces the rotating member of the brushless motor, and a Hall bias current feeding circuit that feeds bias current from the power supply to the Hall element. The Hall element outputs a complementary pair of periodic signals with periods corresponding to a rotational period of the rotating member. The driving circuit also includes a control circuit that controls the driving voltage generating circuit according to the complementary pair of periodic signals.

The driving voltage generating circuit, at least part of the Hall bias current feeding circuit, and the control circuit are integrated into a single integrated circuit which may also include the Hall element.

The driving circuit also includes a load element through which the bias current passes from the power supply to the Hall bias current feeding circuit, producing a voltage drop that reduces the first voltage to a second voltage, lower than the first voltage. The load element is preferably external to the single integrated circuit.

By reducing the first voltage to the second voltage, the load element reduces power dissipation in the Hall bias current feeding circuit, permitting the Hall bias current feeding circuit to be partly or wholly integrated with the driving voltage generating circuit and the control circuit even when the brushless motor is driven at a high voltage.

The Hall bias current feeding circuit may include a Hall bias circuit that generates a control signal, and a switching element that feeds the bias current to the Hall element in response to a control signal. The Hall bias circuit is internal to the single integrated circuit; the switching element may be either internal or external to the single integrated circuit. The switching element is in series with the load element and receives the bias current at the second voltage from the load element. The Hall bias circuit may operate at either the first or the second voltage with comparatively low power dissipation. A conventional integrated circuit configuration may be employed with the load element and the external switching element as external elements.

The Hall bias circuit may control the switching element in response to a command signal received from the control circuit.

### BRIEF DESCRIPTION OF THE DRAWINGS

In the attached drawings:

FIG. 1 is a schematic diagram of a conventional brushless motor driving circuit;

FIG. 2 is a schematic diagram of a novel brushless motor driving circuit;

FIG. 3 is a schematic diagram of the H-bridge circuit in FIG. 2;

FIG. 4 is a timing waveform diagram illustrating the operation of the brushless motor driving circuit in FIG. 2; and

FIGS. 5 and 6 are schematic diagrams of variations of the brushless motor driving circuit in FIG. 2.

### DETAILED DESCRIPTION OF THE INVENTION

Novel driving circuits embodying the invention will now be described with reference to the attached drawings, in which like elements are indicated by like reference characters.

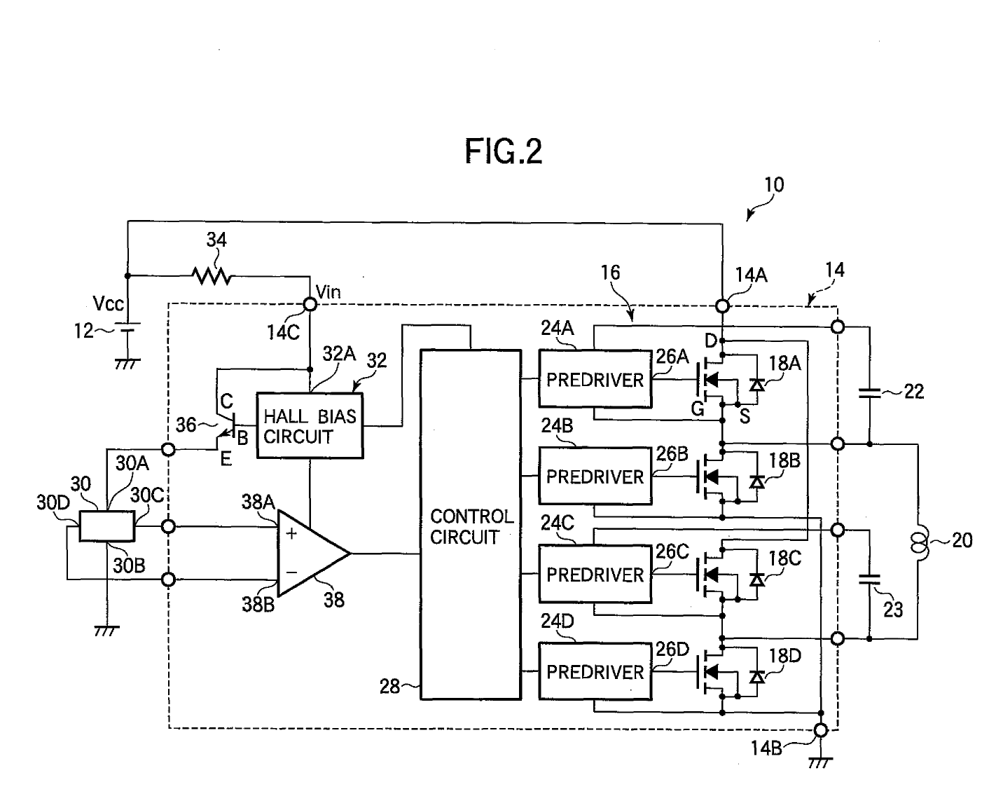

The driving circuit 10 shown in FIG. 2 has a power supply 12 that provides electromotive force at a supply voltage Vcc.

The negative terminal of the power supply 12 is connected to ground; the positive terminal of the power supply 12 is connected to a first voltage (Vcc) input terminal 14A of an integrated circuit 14. The first voltage input terminal 14A is paired with a ground terminal 14B to power an H-bridge and predriver circuit 16 that functions as a driving voltage generating circuit and coil energizing circuit. The H-bridge and predriver circuit 16 is internal to the integrated circuit 14.

The H-bridge and predriver circuit 16 includes four NMOS transistors 18A, 18B, 18C, 18D interconnected in a H-bridge configuration, transistors 18A and 188 forming one totem-pole half-bridge, transistors 18C and 18D forming another totem-pole half-bridge. The first voltage input terminal 14A is connected to the drains (D) of NMOS transistors 18A and 18C, and the sources of NMOS transistors 18B and 18D are connected to the ground terminal 14B. The source (S) of NMOS transistor 18A is connected to the drain of NMOS transistor 18B, and the source of NMOS transistor 18C is connected to the drain of NMOS transistor 18D. One end of a coil 20 in the brushless motor is connected to the source of NMOS transistor 18A and the drain of NMOS transistor 18B; the other end of the coil 20 is connected to the source of NMOS transistor 18C and the drain of NMOS transistor 18D.

The H-bridge configuration of NMOS transistors 18A, 18B, 18C, 18D can be expanded, if necessary, into a multistage power output configuration with a similar set of four transistors in each stage.

A pair of bootstrap capacitors 22, 23 are connected to respective ends of the coil 20 and respective terminals of the integrated circuit 14.

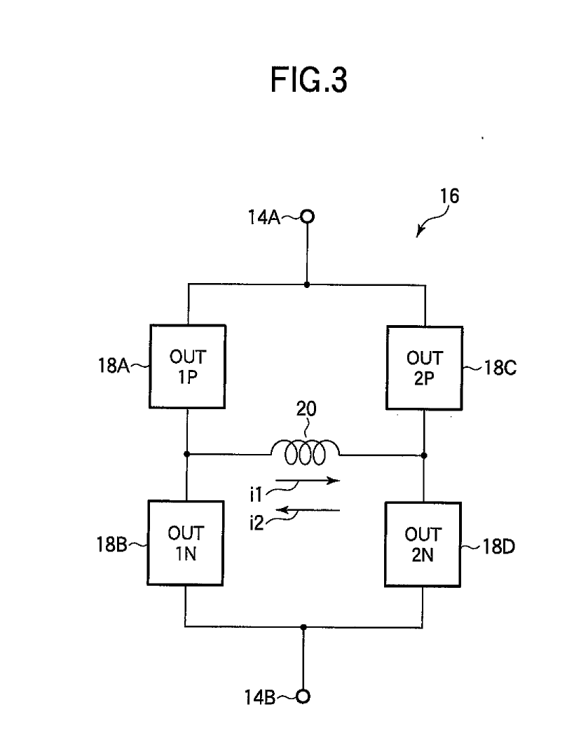

The H-bridge circuit is redrawn in FIG. 3, using the notation OUT1P, OUT1N, OUT2P, OUT2N to indicate the switching signals received at the gates of NMOS transistors 18A, 18B, 18C, 18D. These transistors operate as switching elements. When switching signals OUT1P and OUT2N are high and NMOS transistors 18A and 18D are turned on, a current i1 flows from the half-bridge on the left side to the half-bridge on the right side. When switching signals OUT2P and OUT1N are high and NMOS transistors 18C and 18B are turned on, a current i2 flows from the half-bridge on the right side to the half-bridge on the left side.

Referring again to FIG. 2, the gates (G) of NMOS transistors 18A, 18B, 18C, 18D are connected to the output terminals 26A, 26B, 26C, 26D of respective predrivers 24A, 24B, 24C, 24D. The NMOS transistors 18A, 18B, 18C, 18D become conductive between their source and drain terminals in response to the switching signals output from these predrivers 24A, 24B, 24C, 24D. The predrivers 24A, 24B, 24C, 24D control the NMOS transistors 18A, 18B, 18C, 18D by switching them on and off according to signals received from a control circuit 28. Predrivers 24A and 24C are also connected to the bootstrap capacitors 22, 23.

The control circuit 28 starts operating on command from a device (not shown) external to the integrated circuit 14 to turn on the brushless motor. The control circuit 28 operates by feedback control, receiving a signal indicating the rotational position of the brushless motor from a Hall element 30 disposed facing the rotor of the brushless motor and controlling the predrivers 24A, 24B, 24C, 24D according to this positional feedback signal.

The control circuit 28 operates on power supplied from a Hall bias circuit 32. An operating voltage is applied to a power input terminal 32A of the Hall bias circuit 32 from the power supply 12 through a three-kilohm (3-kΩ resistor 34 and a second voltage (Vin) input terminal 14C of the integrated circuit 14. The resistor 34 functions as a load element.

The Hall bias circuit 32 feeds current to the Hall element 30 by driving the base (B) of an npn bipolar transistor 36 connected as a switching element or current regulating element in series with the resistor 32. The npn bipolar transistor 36 is connected as an emitter follower: its collector (C) is connected to the second voltage input terminal 14C and the power input terminal 32A of the Hall bias circuit 32; its emitter (E) is connected to one current terminal 30A of the Hall element 30. The other current terminal 30B of the Hall element 30 is connected to ground.

The Hall bias circuit 32 and npn bipolar transistor 36 operate together as a Hall bias current feeding circuit.

The Hall element 30 has a pair of voltage signal output terminals 30C, 30D from which it outputs a complementary pair of periodic signals (normally, sinewave signals) with periods corresponding to the rotational period of the rotor of the brushless motor. Because these periodic signals indicate the rotational position of the brushless motor, they will also be referred to as positional signals.

The complementary pair of positional signals are received by the non-inverting input terminal 38A and inverting input terminal 38B of a Hall amplifier 38. Operating on a voltage supplied by the Hall bias circuit 32, the Hall amplifier 38 amplifies the difference between the complementary positional signals and sends the resulting amplified signal to the control circuit 28 as the positional feedback signal mentioned above.

From the amplified positional feedback signal received from the Hall amplifier 38, the control circuit 28 generates the on-off switching signals supplied to the predrivers 24A, 24B, 24C, 24D.

The resistor 34 is a key feature of the novel driving circuit 10 that reduces power dissipation by the Hall bias circuit 32 and npn bipolar transistor 36.

The power supply 12 supplies whatever voltage is needed to power the brushless motor. A comparatively low supply voltage (about 3 V to 5 V) or a comparatively high supply voltage (in the neighborhood of 50 V) may be used according to the specifications of the brushless motor. When a supply voltage in the comparatively high range is used, without resistor 34, the Hall bias circuit 32 and npn bipolar transistor 36 would dissipate too much power to be packaged as part of the integrated circuit 14. Insertion of the resistor 34 reduces power dissipation by the Hall bias circuit 32 and npn bipolar transistor 36 by reducing the voltage (Vin) they receive.

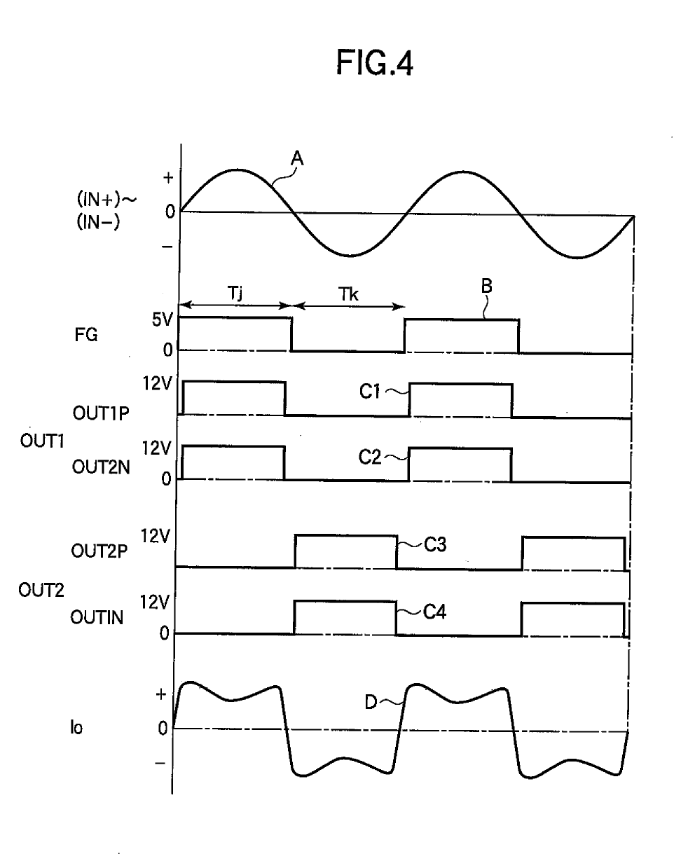

The operation of the embodiment will now be described with reference to FIG. 4. First, the operation of the driving circuit 10 will be described.

The first waveform A in FIG. 4 represents the difference between the non-inverting (IN+) and inverting (IN-) inputs to the Hall amplifier 38, as received from the Hall element 30 when the brushless motor is running.

The second waveform B is a frequency generator (FG) signal generated by the control circuit 28 from the output of the Hall amplifier 38. The control circuit 28 switches the FG signal between high (5 V) and low (0 V) voltage levels at zero-crossing points of waveform A. The FG signal may be output from the integrated circuit 14, although for simplicity, this is not shown in FIG. 2.

The control circuit 28 also generates complementary output signals OUT1 and OUT2. OUT1 is supplied to predrivers 24A and 24D and OUT2 is supplied to predrivers 24B and 24C. The predrivers respond by supplying output signals OUT1P, OUT1N, OUT2P, and OUT2N to the gates of NMOS transistors 18A, 18B, 18C, 18D, respectively, in the H-bridge. The NMOS transistors conduct current between their source and drain terminals when their gate inputs are high. The high level is given as 12 V in FIG. 4, although the actual voltage may vary depending on the supply voltage.

The waveforms of the predriver output signals are shown as waveforms C1 to C3 in FIG. 4. The operation of the control circuit 28 and predrivers 24A-24D is summarized in Table 1.

TABLE 1

| | Control | Predriver | Driven |
|---|---|---|---|
| Waveform | Output | Output | Transistor |
| C1 | OUT1 | OUT1P | NMOS transistor 18A |
| C2 | OUT1 | OUT2N | NMOS transistor 18D |
| C3 | OUT2 | OUT1N | NMOS transistor 18B |
| C4 | OUT2 | OUT2P | NMOS transistor 18C |

During period Tj in FIG. 4, signals OUT1, OUT1P, and OUT2N are high and current II flows from the half-bridge on the left side in FIG. 3 through the coil 20 to the half-bridge on the right side in FIG. 3, through NMOS transistors 18A and 18D. During period Tk in FIG. 4, signals OUT1, OUT1P, and OUT2N go low, signals OUT2, OUT2P, and OUT1N go high, and current i2 flows from the half-bridge on the right side to the half-bridge on the left side in FIG. 3, through NMOS transistors 18B and 18C, reversing the current flow through the coil 20. The current in the coil 20 continues to reverse direction (i1→i2→i1→i2→ . . . ) in this way, as indicated by waveform D in FIG. 4, to provide the brushless motor with torque.

The Hall bias voltage is the emitter voltage of the npn bipolar transistor 36. Since transistor 36 operates as an emitter follower, its emitter voltage differs by a small and substantially constant amount from the base voltage supplied by the Hall bias circuit 32. The collector voltage of transistor 36 is the reduced voltage Vin produced by the voltage drop that occurs when current flows through the resistor 34.

When the supply voltage Vcc output from the power supply 12 at 50 V, for example, if the Hall bias voltage is 3 V, the Hall bias current is 10 mA, the total current consumed by the other control circuits in the integrated circuit 14 is 3 mA, and the resistor 34 connected to the collector of the npn bipolar transistor 36 has a resistance of 3 kΩ, the voltage drop in the resistor 34 is 39 V. The collector voltage Vin of transistor 36 is therefore only 11 V.

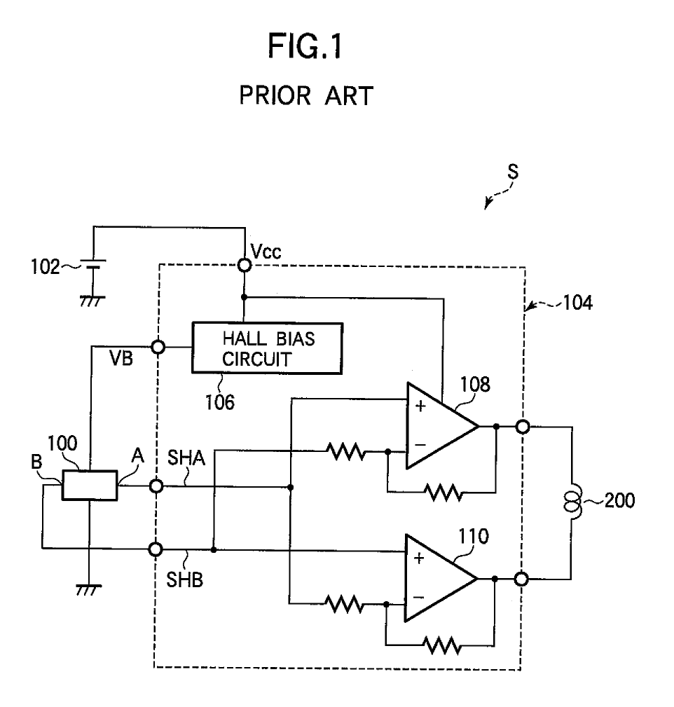

The total power dissipation by the Hall element 30 and the Hall bias circuit 32, transistor 36, and the other control circuits in the integrated circuit 14 is then about 0.14 W (approximately 13 mA×11 V). The total power dissipation by the Hall bias circuit 32 is reduced to about one-fifth the total power (0.65 W) that would be dissipated in the conventional driving circuit S in FIG. 1 with a supply voltage of 50 V, and is within the range in which the Hall bias circuit 32 can be packaged as part of the integrated circuit 14.

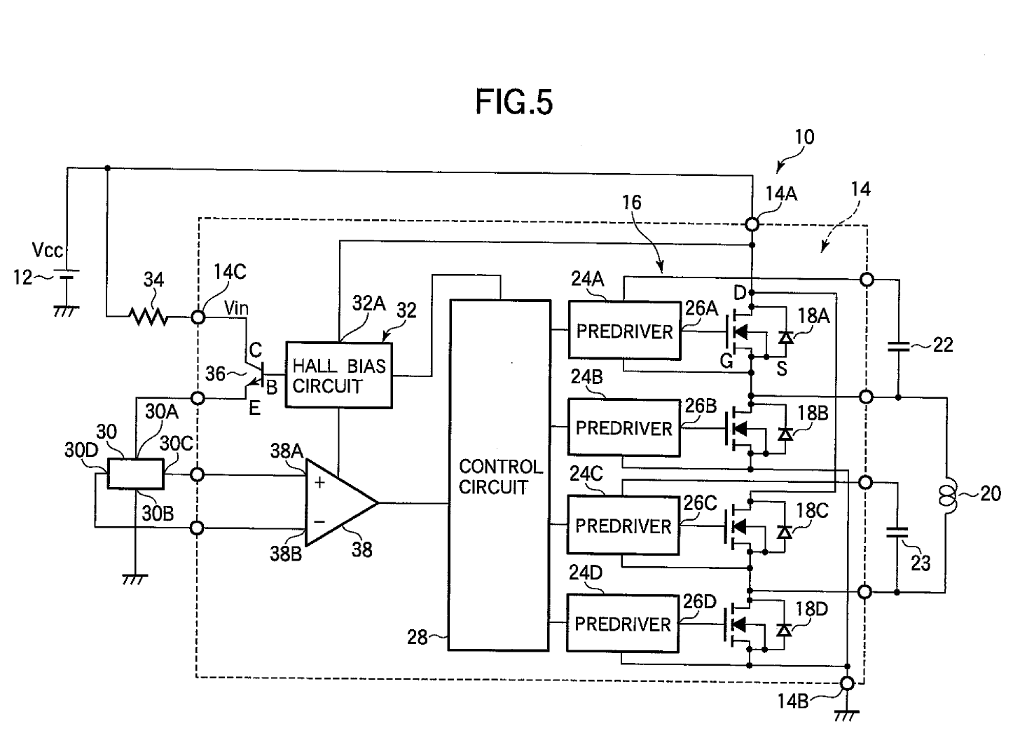

Referring to FIG. 5, in a first variation of the preceding embodiment, the power input terminal 32A of the Hall bias circuit 32 is connected to the Vcc input terminal 14A of the integrated circuit 14 instead of the Vin input terminal 14C. In this variation only the Hall bias current passes through the resistor 34 external to the integrated circuit 14. To produce the same Hall bias voltage of 3 V with a supply voltage Vcc of 50 V, the resistance value of resistor 34 should now be 3.9 kΩ, so 10 mA of current passes through the resistor 34 and the corresponding power dissipation after this current enters the integrated circuit 14 is only 0.11 W, as compared with 0.50 W that would be dissipated by the flow of Hall bias current in the conventional driving circuit S in FIG. 1.

The Hall bias circuit 32 itself dissipates some additional power by operating on Vcc instead of Vin, but the amount is not large, because the base current the Hall bias circuit 32 supplies to the npn bipolar transistor 36 is much less than the 10 mA emitter-collector current.

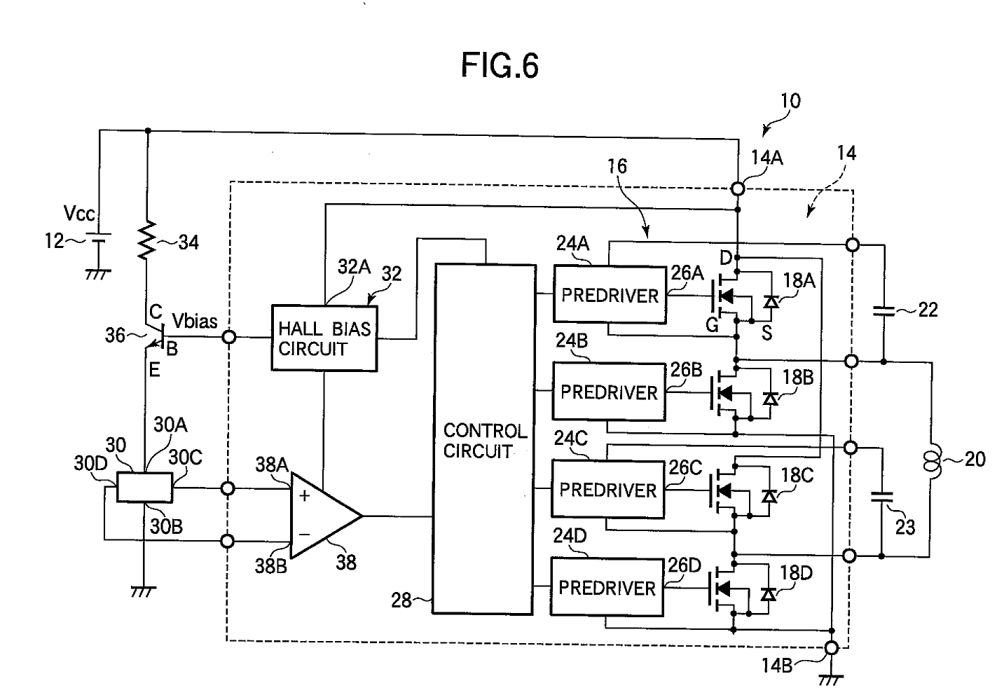

Referring to FIG. 6, in a second variation of the preceding embodiment, the npn bipolar transistor 36 is external to the integrated circuit 14. The power input terminal 32A of the Hall bias circuit 32 is again connected to the Vcc input terminal 14A of the integrated circuit 14. Power dissipation inside the integrated circuit 14 is reduced because the power dissipated in the transistor 36 is dissipated outside the integrated circuit 14. The power dissipated in transistor 36 itself is reduced by the voltage drop in the resistor 34. Since transistor 36 operates as an emitter follower, this variation can be implemented by connecting an external resistor 34 and transistor 36 to a conventional integrated driving circuit.

In a third variation (not separately illustrated), the Hall element 30 is internal to the integrated circuit 14. The npn bipolar transistor 36 may be either internal to the integrated circuit 14, as in FIGS. 2 and 5, or external to the integrated circuit 14, as in FIG. 6. This variation is advantageous when the integrated circuit 14 is fabricated by a process that can also be used to fabricate a Hall element.

In a fourth variation, the resistor 34 is replaced by another type of load element, such as an inductive load element or an energy-conversion element. Energy-conversion elements that can be used as load elements include heating elements and illumination elements. Any type of load element that produces a voltage drop may be used.

In a fifth variation, the control circuit 28 generates a command signal according to the rotation status of the motor and sends the command signal to the Hall bias circuit 32. The Hall bias circuit 32 controls the npn bipolar transistor 36 according to the command signal, e.g., by switching the npn bipolar transistor 36 on and off.

Those skilled in the art will recognize that further variations are possible within the scope of the invention, which is defined in the appended claims.

What is claimed is:

1. A driving circuit using current supplied at a first voltage by a power supply to drive a brushless motor having a rotating member, the driving circuit comprising:
a driving voltage generating circuit for generating voltages for driving the brushless motor;
a Hall element disposed facing the rotating member of the brushless motor, for output of a pair of periodic signals having mutually opposite phase and having periods corresponding to a rotational period of the rotating member;
a Hall bias current feeding circuit for feeding bias current from the power supply to the Hall element;
a load element through which the bias current passes from the power supply to the Hall bias current feeding circuit, for producing a voltage drop that reduces the first voltage to a second voltage lower than the first voltage; and
a control circuit for controlling the driving voltage generating circuit according to the pair of periodic signals output from the Hall element; wherein
the driving voltage generating circuit, at least part of the Hall bias current feeding circuit, and the control circuit are integrated into a single integrated circuit.

2. The driving circuit of claim 1, wherein the Hall element is internal to the single integrated circuit.

3. The driving circuit of claim 1, wherein the Hall element is external to the single integrated circuit.

4. The driving circuit of claim 1, wherein the load element is external to the single integrated circuit.

5. The driving circuit of claim 1, wherein the load element is a resistor.

6. The driving circuit of claim 1, wherein the load element is a heating element.

7. The driving circuit of claim 1, wherein the load element is an illumination element.

8. The driving circuit of claim 1, wherein the load element is an inductive load element.

9. The driving circuit of claim 1, wherein the Hall bias current feeding circuit operates entirely on power supplied at the second voltage through the load element.

10. The driving circuit of claim 1, wherein the Hall bias current feeding circuit further comprises:
a Hall bias circuit, internal to the single integrated circuit, for generating a control signal; and
a switching element for feeding the bias current to the Hall element in response to the control signal, the switching element being in series with the load element and receiving the bias current at the second voltage from the load element.

11. The driving circuit of claim 10, wherein the switching element is a transistor with a control electrode for receiving the control signal.

12. The driving circuit of claim 10, wherein the switching element is a bipolar transistor with a base terminal for receiving the control signal, a collector terminal connected to the load element, and an emitter terminal connected to the Hall element.

13. The driving circuit of claim 10, wherein the switching element is internal to the single integrated circuit.

14. The driving circuit of claim 10, wherein the switching element is external to the single integrated circuit.

15. The driving circuit of claim 10, wherein the Hall bias circuit operates on current supplied from the power supply through the load element at the second voltage.

16. The driving circuit of claim 10, wherein the Hall bias circuit operates on current supplied from the power supply at the first voltage.

17. The driving circuit of claim 10, wherein the control circuit generates a command signal and the Hall bias circuit generates the control signal according to the command signal.
